(19) United States
(12) Patent Application Publication
(10) Pub. No.: US 2015/0280946 A1
(43) Pub. Date: Oct. 1, 2015

(54) FEEDBACK RECEIVE PATH WITH LOW-IF MODE

(71) Applicant: QUALCOMM Incorporated, San Diego, CA (US)

(72) Inventors: Faramarz Sabouri, San Diego, CA (US); Seyed Aiden Bassam, San Diego, CA (US); Desong Zhao, San Diego, CA (US); Carl Thomas Hardin, Encinitas, CA (US); Sahar Nozari, San Diego, CA (US)

(21) Appl. No.: 14/664,550

(22) Filed: Mar. 20, 2015

Related U.S. Application Data
(60) Provisional application No. 61/971,211, filed on Mar. 27, 2014.

(51) Int. Cl. H04L 25/06

(52) U.S. Cl. CPC H04L 25/063

(57) ABSTRACT

An apparatus includes an input configured to receive a radio-frequency (RF) signal at a feedback receive path and also includes circuitry coupled to the input. The circuitry is configured to generate a low-intermediate frequency (low-IF) signal based on the RF signal.

### I. CROSS-REFERENCE TO RELATED APPLICATIONS

The present application claims priority from U.S. Provisional Patent Application No. 61/971,211, filed Mar. 27, 2014 and entitled “TRANSMIT POWER CONTROL USING A RECEIVER FEEDBACK PATH,” the content of which is incorporated by reference in its entirety.

### II. FIELD

The present disclosure relates generally to electronics, and more specifically to feedback receive paths.

### III. DESCRIPTION OF RELATED ART

It is generally desirable to reduce the die area used for transmitters and receivers. Because die area is sometimes limited by the number of interface pins available, reducing a number of pins may enable die area to be reduced.

Transmit power control may be accomplished using open loop power control. Open loop power control can increase factory calibration time, may be subject to accuracy degradation due to power supply variation and temperature variation, and may use a complex look-up table. Alternatively, a feedback receiver can be used to detect and downconvert a transmitted signal to produce signal information that can be used in a feedback loop to control transmission power.

### IV. BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a diagram showing a wireless device communicating with a wireless communication system.

FIG. 2 is a diagram of the wireless device of FIG. 1 that depicts components including a feedback receive path operable in a low-intermediate frequency (low-IF) mode and operable in a baseband or zero-IF mode.

FIG. 3 is another diagram of the wireless device of FIG. 1 that depicts components including the feedback receive path of FIG. 2 having a heterodyne configuration and operating in the low-IF mode.

FIG. 4 is another diagram of the wireless device of FIG. 1 that depicts components including the feedback receive path of FIG. 2 operable in the low-IF mode and also including a receive path that may be used to transmit a feedback receive signal to a digital baseband device.

FIG. 5A is a graphical diagram of power levels that may be used in a transmit power control operation that may be performed by the wireless device of FIG. 1.

FIG. 5B is a graphical diagram illustrating timing of an on-chip power estimation of a signal at a feedback receive path, the on-chip power estimation performed by the wireless device of FIG. 1 during the transmit power control operation of FIG. 5A.

FIG. 6 illustrates an exemplary embodiment of a method that may be performed in the wireless device of FIG. 1.

### V. DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein may include files that are not executable in nature, such as documents that may need to be opened or other data files that need to be accessed.

As used herein, the term “on-line” refers to performing transmit power control such as described herein while a communication device is in use, such as when engaged in a data or voice communication session.

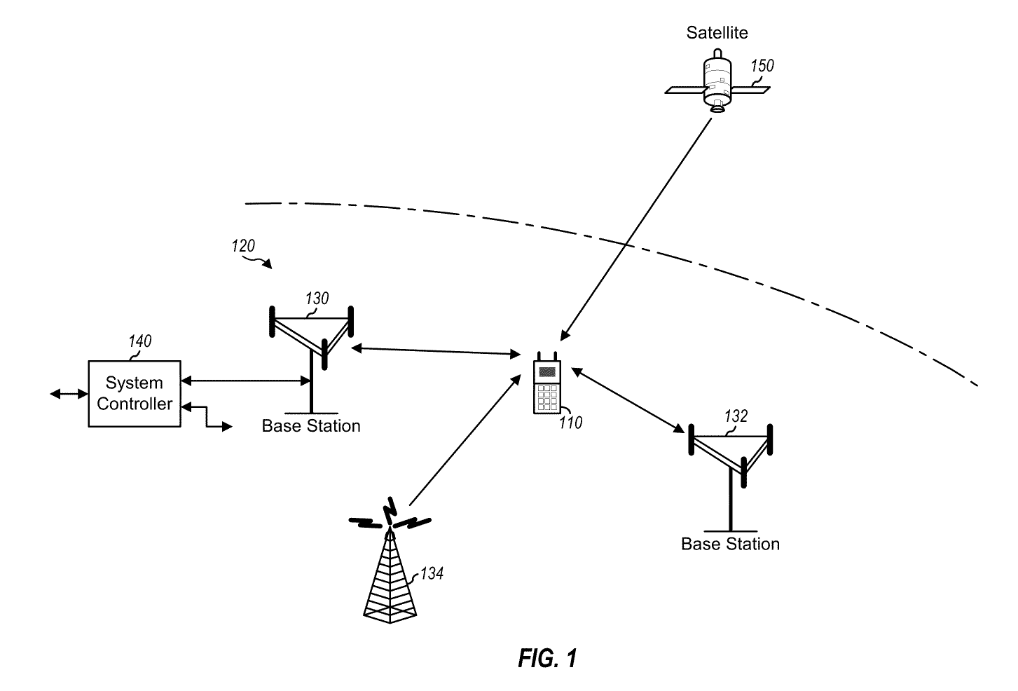

FIG. 1 is a diagram showing a wireless device 110 communicating with a wireless communication system 120. The wireless communication system 120 may be a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1X, Evolution-Data Optimized (EVDO), Time Division Synchronous CDMA (TD-SCDMA), or some other version of CDMA. For simplicity, FIG. 1 shows wireless communication system 120 including two base stations 130 and 132 and one system controller 140. In general, a wireless communication system may include any number of base stations and any set of network entities.

The wireless device 110 may also be referred to as user equipment (UE), a mobile station, a terminal, an access terminal, a subscriber unit, a station, etc. Wireless device 110 may be a cellular phone, a smartphone, a tablet, a wireless modem, a personal digital assistant (PDA), a handheld device, a laptop computer, a smartbook, a netbook, a tablet, a cordless phone, a wireless local loop (WLL) station, a Bluetooth device, etc. Wireless device 110 may communicate with wireless communication system 120. Wireless device 110 may also receive signals from broadcast stations (e.g., a broadcast station 134), signals from satellites (e.g., a satellite 150) in one or more global navigation satellite systems (GNSS), etc. Wireless device 110 may support one or more radio technologies for wireless communication such as LTE, WCDMA, CDMA 1X, EVDO, TD-SCDMA, GSM, 802.11, etc.

Wireless device 110 may support carrier aggregation, which includes operation on multiple carriers. Carrier aggregation may also be referred to as multi-carrier operation. Wireless device 110 may be configured to operate in a low-band (LB) frequency band group (e.g., a “band group” of one or more frequency bands in which a highest frequency included in the one or more frequency bands does not exceed 1000 megahertz (MHz)), a mid-band (MB) frequency band group (e.g., a band group of one or more frequency bands in which a lowest frequency included in the one or more frequency bands exceeds 1000 MHz and in which a highest frequency included in the one or more frequency bands does not exceed 2300 MHz), and/or high-band (HB) frequency band group (e.g., a band group of one or more frequency bands in which a lowest frequency included in the one or more frequency bands exceeds 2300 MHz). For example, low-band may cover 698 to 960 MHz, mid-band may cover 1475 to 2170 MHz, and high-band may cover 2300 to 2690 MHz and 3400 to 3800 MHz. Low-band, mid-band, and high-band refer to three groups of bands (or band groups), with each band group including a number of frequency bands (or simply, “bands”). In some implementations, each band may have a bandwidth that is less than or equal to 200 MHz and may include one or more carriers. Each carrier may cover up to 20 MHz in LTE. LTE Release 11 supports 35 bands, which are referred to as LTE/UMTS bands and are listed in 3GPP TS 36.101.

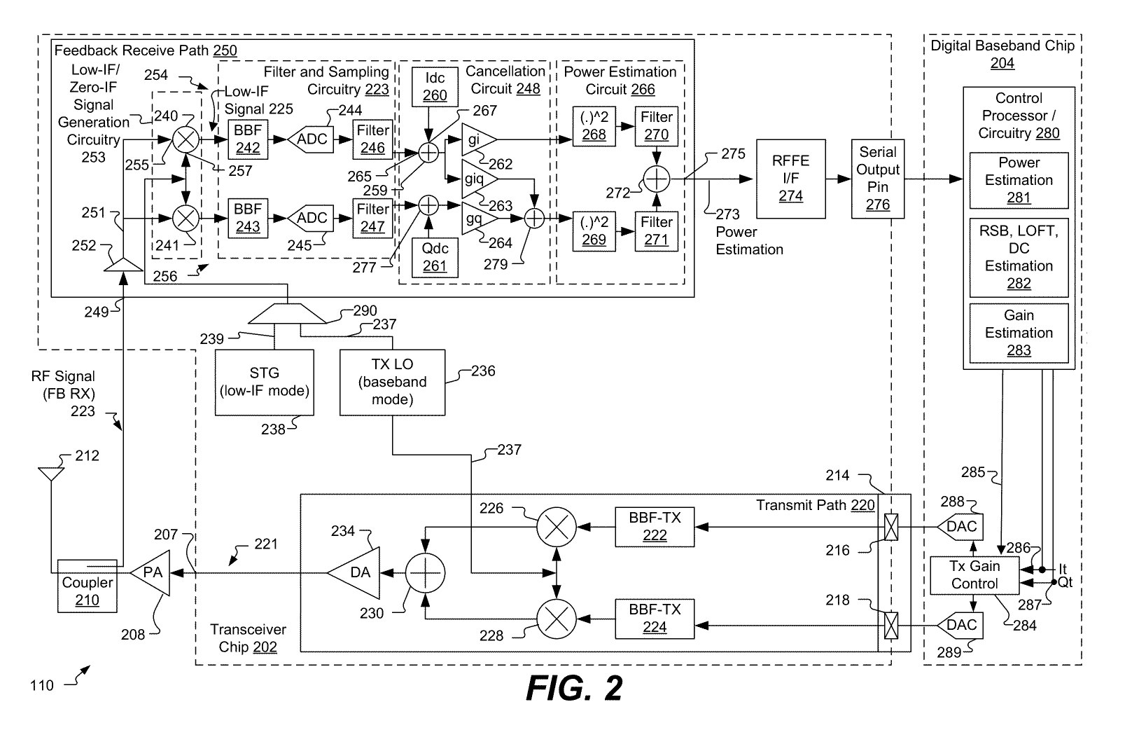

Wireless device 110 may include a transceiver that has a transmit path to generate a wireless signal for transmission. A feedback receive (FBRx) path of the wireless device 110 may process a portion of the transmitted signal and may include an energy measurement circuit to enable the wireless device 110 to perform power control of the transmitted signal. The receive feedback path is configured to operate in a low-intermediate frequency (low-IF) mode. For example, the feedback receive path may be operated in the low-IF mode to determine one or more parameters, such as a direct-current (DC) offset to compensate for an inaccurate DC voltage level in a baseband portion of the feedback receive path. The determined parameters may be used by the feedback receive path to modify a feedback signal to reduce an effect of non-ideal signal processing components of the feedback receive path. Modifying the feedback signal may improve the accuracy of the energy measurement circuit during operation in a baseband (i.e., a zero-intermediate frequency (ZIF)) mode of operation. Examples of the receive feedback path of the wireless device 110 are described in further detail with respect to FIGS. 2-4.

FIG. 2 shows a block diagram of an exemplary design of the wireless device 110 in FIG. 1. In this exemplary design, the wireless device 110 includes a transceiver on a transceiver chip 202 that is coupled to a digital baseband chip 204. The transceiver chip 202 includes a transmit path 220 and a feedback receive path 250 that is coupled to the transmit path 220. The feedback receive path 250 is operable in a low-IF mode and in a baseband mode.

The transit path 220 includes a baseband input 214 and a radio frequency (RF) output 207. The baseband input 214 includes an interface, such as a first analog input pin 216 configured to receive an in-phase (I) signal (e.g., an I component of a transmit signal) and a second analog input pin 218 configured to receive a quadrature (Q) signal (e.g., a Q component of the transmit signal). Baseband filters 222, 224 are configured to filter the received I and Q signals. Mixers 226, 228 are configured to multiply the outputs of the baseband filters 222, 224, respectively, with a transmit local oscillator (TX LO) signal 237 to generate upconverted (frequency-shifted) RF versions of the I and Q signals. A combiner 230 is configured to combine the RF I and Q signals, and an amplifier 234 is configured to provide a resulting RF transmit signal 221 at the RF output 207.

A power amplifier 208 may be coupled to the RF output 207 and configured to provide an amplified version of the RF transmit signal 221 to an antenna 212 via a coupler 210. The coupler 210 may be configured to provide a RF signal 223, such as a portion or a sample of the amplified version of the RF transmit signal 221 (e.g., a feedback receive signal) to an input 249 of the feedback receive path 250 for use in power estimation and closed-loop transmit power control.

The input 249 of the feedback receive path 250 is coupled to the RF output 207 (e.g., via the coupler 210 and the power amplifier 208). The input 249 is configured to receive the RF signal 223 at the feedback receive path 250. The feedback receive path 250 includes low-IF/zero-IF signal generation circuitry 253, filter and sampling circuitry 223 coupled to the low-IF/zero-IF signal generation circuitry 253, a cancellation circuit 248 coupled to the low-IF/zero-IF signal generation circuitry 253 via the filter and sampling circuitry 223, and a power estimation circuit 266.

The low-IF/zero-IF signal generation circuitry 253 is coupled to the input 249 and is configured to generate a low-IF signal 225 based on the RF signal 223. For example, the low-IF/zero-IF signal generation circuitry 253 may be configured to switch between a low-IF mode and a baseband (e.g., zero-IF) mode, as described in further detail below. The low-IF/zero-IF signal generation circuitry 253 includes a mixer 240 having a first mixer input 255 coupled to the input 249. The mixer 240 has a second mixer input 257. The second mixer input 257 is coupled to a single tone generator circuit 238 in the low-IF mode and coupled to a local oscillator circuit 236 in the baseband mode. The low-IF/zero-IF signal generation circuitry 253 is configured to downconvert an RF feedback signal 251 (e.g., an amplified version of the RF signal 223) to a baseband signal or to a low-IF signal. To illustrate, an amplifier 252, such as a low noise amplifier (LNA), is coupled to the input 249 and has an output coupled to the mixer 240 in an I processing path 254 and to a mixer 241 in a Q processing path 256. The mixers 240, 241 are configured to downconvert a received RF feedback signal 251 to generate downconverted signals that are provided to baseband filters 242, 243, respectively.

The filter and sampling circuitry 223 includes the baseband filters 242, 243, analog-to-digital converters (ADCs) 244, 245, and filters 246, 247. The analog-to-digital converter (ADC) 244 is in the I processing path 254 and is configured to sample and convert the filtered downconverted I signal to a digital I signal that is provided to the filter 246. The analog-to-digital converter (ADC) 245 is in the Q processing path 256 and is configured to sample and convert the filtered downconverted Q signal to a digital Q signal that is provided to the filter 247.

The cancellation circuit 248 may be configured to apply a direct-current (DC) offset to a feedback receive signal at the feedback receive path 250. For example, the cancellation circuit 248 may include an adder 259 having a first adder input 265 coupled to receive a feedback receive signal (e.g., an I signal received from the filter 246) and having a second adder input 265 coupled to receive a DC offset, such as an in-phase DC offset (Idc) 260. The adder 259 may be configured to apply the Idc 260 to the I signal received from the output of the filter 246. The cancellation circuit 248 may also include a second adder 277 that is coupled to receive a second feedback receive signal (e.g., a Q signal received from the filter 247) and a second DC offset, such as a quadrature DC offset (Qdc) 261. The second adder 277 may be configured to apply Qdc 261 to the Q signal received from the output of the filter 247.

The cancellation circuit 248 may also be configured to apply one or more gains to at least partially compensate for local oscillator (LO) carrier leakage and/or other residual side band (RSB) components. A first amplifier 262 may apply a gain “gi” to the I signal, a second amplifier 263 may apply a gain “giq” to the I signal and provide an output signal to an input of an adder circuit 279 in the Q processing path 256, and a third amplifier 264 may apply a gain “gq” to the Q signal and provide an output to another input of the adder circuit 279 in the Q processing path 256.

The feedback receive path 250 includes a power estimator circuit 266 that is coupled to the cancellation circuit 248 and to an output 275 of the feedback receive path and that is configured to generate a power estimation 273. The power estimator circuit 266 receives an I input signal from the output of the first amplifier 262 of the cancellation circuit 248 and receives a Q input signal from the output of the adder circuit in the Q processing path 256 of the cancellation circuit 248. The power estimation 273 may be generated based on a low-IF signal or baseband signal (e.g., generated by the mixers 240, 241) corresponding to the RF transmit signal 221 of the transmit path 220.

The power estimator circuit 266 includes a first squaring circuit 268 coupled to receive samples of a first feedback signal in the feedback receive path 250. For example, the first squaring circuit 268 may be configured to generate a value corresponding to a square of a sample of the first feedback signal (e.g., an I input signal) in the feedback receive path 250. The power estimator circuit 266 further includes a second squaring circuit 269 coupled to receive samples of a second feedback signal in the feedback receive path 250. For example, the second squaring circuit 269 may be configured to generate a second value corresponding to a square of a second sample of the second feedback signal (e.g., a Q input signal) in the feedback receive path 250. Outputs of the squaring circuits 268, 269 may be filtered by filters 270, 271 (e.g., to integrate the squares of the signal samples) and the filtered outputs may be provided to inputs of an adder, such as an adder circuit 272, that is coupled to the first squaring circuit 268 (e.g., via the filter 270) and to the second squaring circuit 269 (e.g., via the filter 271). An output of the adder circuit 272 provides the power estimation 273. The power estimation 273 is an estimation of the power of the RF feedback signal 251.

The feedback receive path 250 may include a serial output pin 276 (e.g., coupled to the power estimator circuit 266 via a RF front-end (RFFE) serial interface 274). The serial output pin 276 is configured to send the power estimation 273 of the RF feedback signal 251 to the digital baseband chip 204.

The digital baseband chip 204 includes a control processor/circuitry 280 coupled to a transmit gain control circuit 284. The transmit gain controller circuit 284 includes inputs to receive an I transmit component (It) 286 and a Q transmit component (Qt) 287 of a signal to be transmitted and also includes an input to receive a gain control signal 285 from the control processor/circuitry 280. The transmit gain controller circuit 284 is configured to provide gain-adjusted I and Q output signals to digital-to-analog convertors (DACs) 288 and 289, respectively, the gain-adjusted I and Q output signals to be sent to the pins 216, 218 of the baseband input 214 of the transmit path 220.

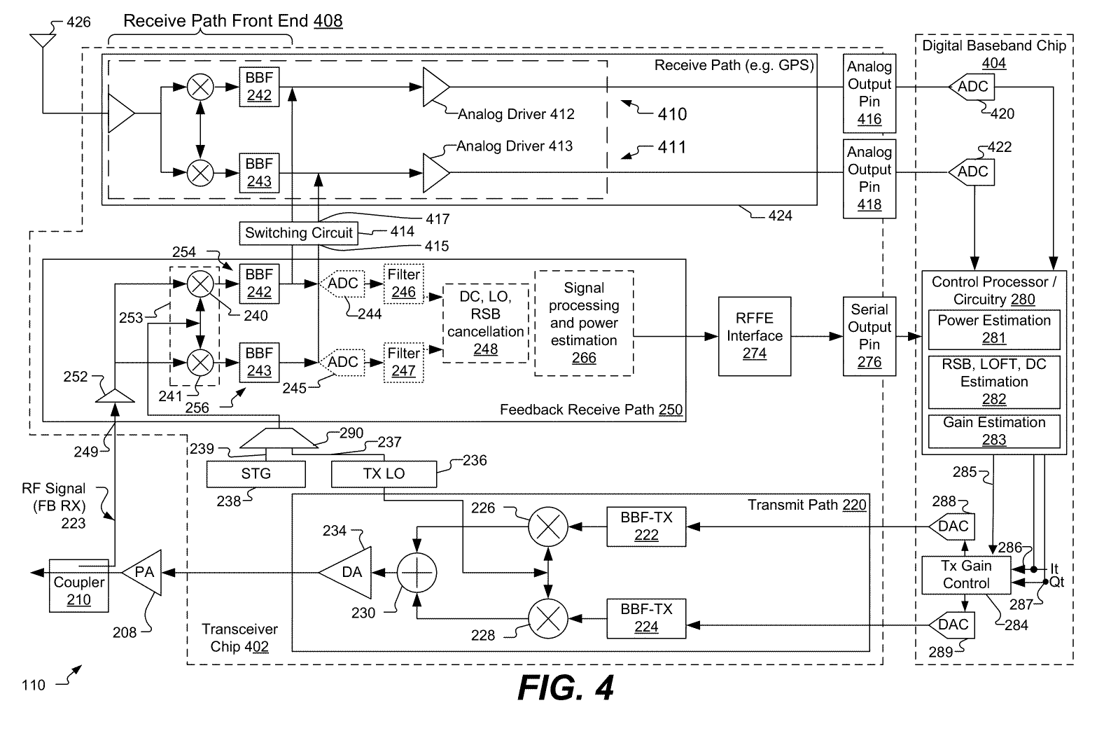

The control processor/circuitry 280 may include a power estimator 281 that is configured to generate an estimated transmit power based on information received from the feedback receive path 250. For example, the power estimator 281 may be configured to perform one or more calculations using one or more digital power estimations 273 received via the serial output pin 276. As another example, the power estimator 281 may be configured to determine a power estimation based on I and Q components corresponding to the feedback receive signal 251 that are received via one or more analog pins, as described in further detail with respect to FIG. 4. The power estimator 281 may be configured to generate a power estimation at least partially based on the received transmit signal (e.g., based on the transmit signal components It 286 and Qt 287 received at the digital baseband chip 404). For example, the power estimator 281 may be configured to determine a correlation between a transmit waveform and a feedback waveform corresponding to the RF feedback signal 251.

The control processor/circuitry 280 may include a parameter estimator 282. The parameter estimator 282 may be configured to determine one or more parameter values that may be used by the cancellation circuit 248. For example, the parameter estimator 282 may be configured to receive data from the feedback receive path 250 while the feedback receive path 250 operates in the low-IF mode. The digitized low-IF signal in the control processor/circuitry 280 and parameter estimator 282 may downconvert to complex I and Q baseband signals.

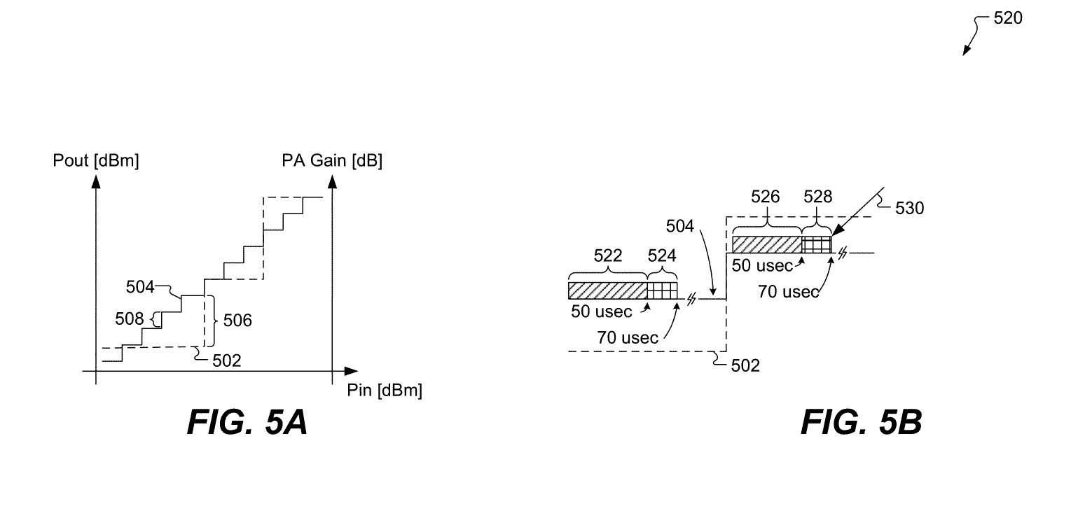

The control processor/circuitry 280 may include a gain estimator 283 that is configured to generate the gain control signal 285. For example, the gain estimator 283 may compare a power estimate (e.g., from the power estimator 281) to a specified power level and generate the gain control signal 285 based on a result of the comparison. To illustrate, the gain estimator 283 may determine an amount of deviation between an expected transmit power level and the estimated power and, based on the deviation, determine a gain adjustment amount, or determine a next gain step during a power level control loop, as described in further detail with respect to FIGS. 5A-5B.

During operation, the feedback receive path 250 is configured to switch between the low-IF mode and a baseband mode. To illustrate, each mixer 240, 241 is configured to switch (e.g., via a control input of a switching circuit 290) between receiving the local oscillator signal 237 from the transmit local oscillator circuit 236 to downconvert the RF feedback signal 251 to generate a baseband signal in the baseband mode and receiving a single tone generator signal 239 from the single tone generator circuit 238 to downconvert the RF feedback signal 251 to generate a low-IF signal in the low-IF mode.

Because the DC offset (e.g., Idc 260 and/or Qdc 261) applied by the cancellation circuit 248 may be difficult to determine in the baseband mode, the feedback receive path 250 may be configured to operate in the low-IF mode to determine the DC offset. The feedback receive path 250 may be configured to switch from the low-IF mode to the baseband mode after the DC offset is determined. The cancellation circuit 248 applies the DC offset (e.g., Idc 260 and/or Qdc 261) to the feedback receive signal in the baseband mode.

To illustrate, during a calibration operation, the control processor/circuitry 280 may generate a first control signal (not shown) to cause one or more of the mixers 240, 241 to receive the single tone generator signal 239 from the switching circuit 290 for low-IF operation in the feedback receive path 250. Based on the power estimation 273 from the feedback receive path 250, the parameter estimator 282 may generate one or more parameter values that are provided to the cancellation circuitry 248 via one or more additional control signals.

After updating the parameter values, the control processor/circuitry 280 may exit the calibration operation and generate a second control signal (not shown) to cause the mixers 240, 241 to receive the TX LO signal 237 from the switching circuit 290 for baseband operation in the feedback receive path 250. In the baseband operation, power control operations may be performed using on-chip power estimation in the feedback receive path 250.

In the exemplary embodiment shown in FIG. 2, feedback receive (FBRx) functionality is implemented using the on-line FBRx path 250 with on-chip power estimation using the in-phase/quadrature signals (I/Q paths 254, 256, respectively). Use of the on-chip power estimation may overcome transmit power control challenges. The feedback receive path 250 may use a zero intermediate frequency (ZIF) or a non-ZIF (e.g., low-IF) interface to the digital baseband (BB) chip 204 through the serial interface (RFFE interface) 274. This FBRx functionality may be implemented using an existing serial output pin 276 and without requiring any additional pins (e.g., without dedicated analog I and Q feedback pins) to be added to the transceiver chip 202. The feedback receive path 250 downconverts the transmit (Tx) signal power and integrates Î2+Q̂2 for power estimation. Embedded DC offset and residual side band (RSB) calibration for the FBRx path 250 is performed by placing the FBRx path 250 into the low-IF mode to avoid errors due to DC offset and performs an embedded gain calibration.

Power estimation accuracy may be improved by avoiding or reducing interference from other signals while the output of the feedback receive path 250 is transmitted to the digital baseband chip 204. Measurements of transmit power may be scheduled to reduce or eliminate crosstalk by selecting measurement time periods to avoid or limit interference from other transmitting operations (e.g., GPS, Wi-Fi, etc.).

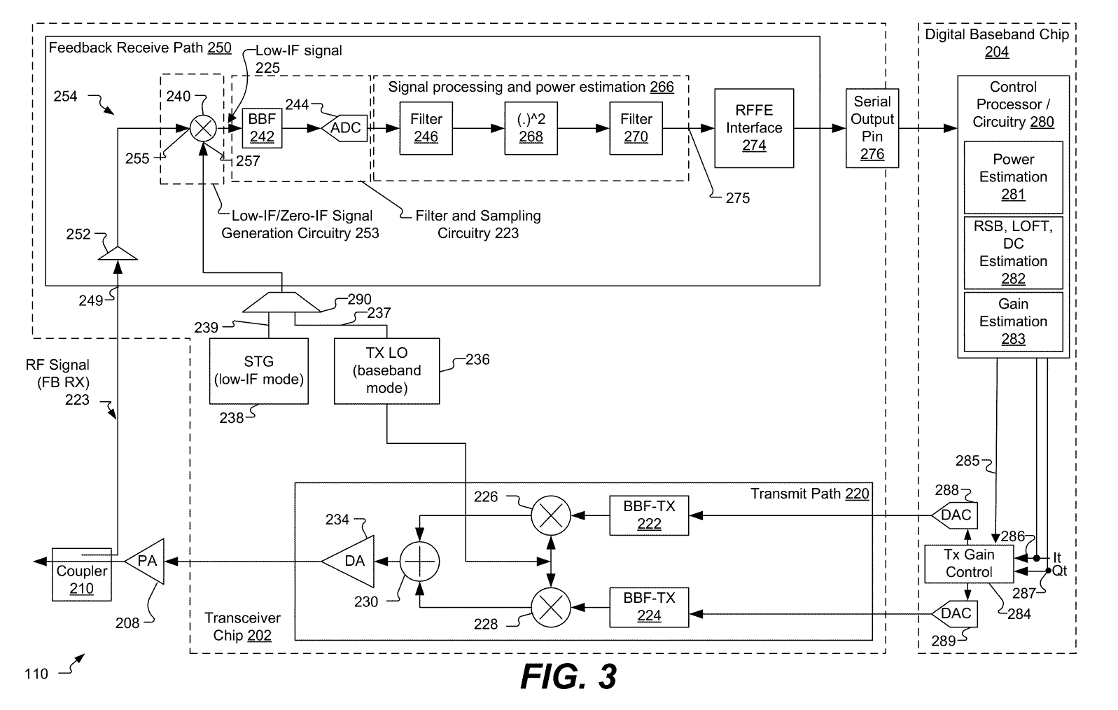

The digital baseband chip 204 may determine a transmit gain adjustment based on the result of the power estimation to adjust the transmit gain control circuit 284. By estimating the power “on-chip” in the transceiver chip 202 and sending a digital numerical result (e.g., the power estimation 273) to the digital baseband chip 204 via the serial interface 274, fewer pins may be used as compared to a system that provides I and Q signals to the digital baseband chip 204 for power estimation at the digital baseband chip 204. In addition, power usage and chip area may be reduced by omitting analog pin driver circuitry and instead using the single serial pin 276 for the feedback receive path 250. The cancellation block 248 of the feedback receive path 250 may improve the power estimation by cancelling an estimated DC component (Idc 260, Qdc 261) of the received I and Q signals. The DC component may be estimated by reconfiguring the feedback receive path 250 to operate in a low-IF mode, as illustrated in FIG. 3.

FIG. 3 shows a second exemplary design of the wireless device 110 in FIG. 1. In this second exemplary design, the wireless device 110 includes the digital baseband chip 204 and the transceiver chip 202 of FIG. 2. The transceiver chip 202 includes the transmit path 220 and the feedback receive path 250 that is coupled to the transmit path 220. The feedback receive path 250 is operated in a low-IF mode. For example, the mixer 240 is configured to receive the STG signal 239 output from the switching circuit 290.

As illustrated, the feedback receive path 250 may operate in a heterodyne configuration in which the Q processing path 256 of FIG. 2 (not shown) of the feedback receive path 250 is disabled, and the mixer 240 in the I processing path 254 receives the STG signal 239 to generate a low-IF downconverted I signal. Signal power of the low-IF downconverted I signal may be estimated and provided to the digital baseband chip 204 via the serial interface 274. The parameter estimator 282 of the digital baseband chip 204 may perform one or more operations to estimate DC power, residual side band (RSB), and LO parameters for use in the cancellation circuit 248 of FIG. 2. The ability of the feedback receive path 250 to switch between low-IF and baseband operation enables computation of the DC offset (Idc 260, Qdc 261) and/or other parameters in the low-IF mode to be used by the cancellation circuit 248 for improved power estimation in the ZIF mode.

FIG. 4 depicts an optional operating mode of a transceiver chip 402 coupled to a digital baseband chip 404 in which the downconverted I and Q signals of the feedback receive path 250 of FIG. 2 are routed to a receive path 424, such as a GPS receive path, while the receive path 424 is not otherwise in use. The transceiver chip 402 includes the transmit path 220 and the feedback receive path 250 of FIG. 2 and also includes the receive path 424. The transceiver chip 402 includes multiple pins that are configured to be coupled to the baseband chip 404. For example, the receive path 424 is configured to be coupled to the digital baseband chip 404 via an analog output pin or multiple analog output pins, such as analog output pins 416, 418 corresponding to I and Q output signals, respectively.

The receive path 424 includes a receive path front end 408 that may be configured to be coupled to an antenna 426. The receive path front-end 408 may include one or more LNAs, mixers, and filters along an I processing path 410 and a Q processing path 411. A downconverted I signal that is output by the receive path front end 408 may be provided to an analog driver 412 that is coupled to the analog output pin 416. A downconverted Q signal that is output by the receive path front end 408 may be provided to an analog driver 413 that is coupled to the analog output pin 418.

When the receive path front end 408 is not in use, such as when the receive path 424 is a GPS receive path and when GPS operation is disabled, a switching circuit 414 may be configured to selectively couple the feedback receive path 250 to the receive path 424 to route a feedback receive signal to the baseband chip 404 via an analog output pin (e.g., via I and Q output pins 416, 418). The switching circuit 414 may include one or more inputs, such as a representative switching circuit input 415, coupled to an output of the circuitry 253 and may also include one or more outputs, such as a representative switching circuit output 417, coupled to the receive path 424. For example, the switching circuit 414 may couple outputs of the bandpass filters 242, 243 to inputs of the analog drivers 412, 413, respectively. Components of the feedback receive path 250, such as the ADCs 244, 245, the filters 246, 247, the cancellation circuit 248, and the power estimator circuit 266, may be powered off or otherwise placed in a low-power consumption state (e.g., by deactivating a headswitch or a footswitch (not shown) when the switching circuit 414 couples the feedback receive path 250 to the receive path 424).

Analog feedback receive I and Q signals may be received at ADCs 420, 422 at the baseband chip 404 from the analog output pins 416, 418, respectively. The controller processor/circuitry 280 may be configured to use the received I and Q signals during a power control operation, such as by correlating the received I and Q signals to the transmit signal (It, Qt) at the power estimator 281.

Re-using the analog pins and drivers of the receive path 424 (e.g., a GPS path) enables the downconverted I and Q signals to be provided to the digital baseband chip 404 without adding additional pins and drivers to the transceiver chip 402. The digital baseband chip 404 may compute a more accurate power estimate using the received analog signals (e.g., by correlating the transmission I and Q waveforms (It, Qt) with the I and Q signals received from the receive path 424) than may be possible at the power estimation circuit 266 of the feedback receive path 250. Applying correlation techniques mitigates power estimation dependency on the signal statistical properties, and reduces power estimation uncertainty.

FIGS. 5A and 5B are diagrams showing an exemplary embodiment of applying transmit power control using the feedback receive path 250 of FIGS. 2-4. In an exemplary embodiment, the feedback receive path 250 provides on-line power estimation for inner loop power control (ILPC), and the digital baseband chip 202 of FIG. 2-3 or the digital baseband chip 404 of FIG. 4 uses estimated power information to update transmit front end (FE) gain, such as via the gain control signal 285 of FIG. 2.

FIG. 5A shows input power (dBm) on the horizontal axis, output power (dBm) on the left vertical axis and power amplifier (PA) gain (dB) (e.g., a gain of the PA 208 of FIGS. 2-4) on the right vertical axis. A first trace 502 illustrates PA gain as a staircase-type function of input power. A second trace 504 illustrates output power as a staircase-type function of input power having a smaller step size than the first trace 502. In an exemplary embodiment, the trace shows that enabling receiver feedback power estimation and power control limits the change in output power to 1 dB increments (e.g., a step height 508) at PA gain switching points (e.g., a PA gain increase 506) even in the presence of potential error in the PA gain increments.

FIG. 5B shows that the transmit power control as described with respect to FIGS. 2-3 can be used at PA switch points where PA gain may vary from factory calibration, and that enabling receiver feedback power estimation and power control at the PA switching point could correct for errors in gain increments that may occur when the gain of the PA switches from a first gain level to a second gain level. In an exemplary embodiment, PA gain calibration may be performed during (e.g., embedded in) an ILPC operation as gain steps are measured based on power estimation at the feedback receive path 250 of FIGS. 2-3 and errors in the gain steps are corrected.

In the diagram of FIG. 5B, a portion of the first trace 502 (PA gain on a first vertical axis) and the second trace 504 (output power on a second vertical axis) are illustrated as a function of time (horizontal axis) during an ILPC operation. A first time period 522 after a transition in output power from a lower level to a higher level may correspond to a latency between the output power transition and generation of a power estimate 273 corresponding to the higher level. A second time period 524 may correspond to transmission of the power estimate 273 to the digital baseband chip 202 via the serial interface 274 and completion of gain estimation by the gain estimator 283 in the control processor/circuitry 280. In an exemplary embodiment, the first time period 522 may be about 50 microseconds and the second time period 524 may be about 20 microseconds.

A third time period 526 corresponds to an amount of time to generate an updated power estimate, and a fourth time period 528 corresponds to an amount of time to generate an updated gain estimation after a PA gain step. After the fourth time period 528, a power correction may be applied at a time 530 to a front-end of the transmit path 220 to correct for a difference between a specified power output (e.g., as specified by a TD-SCDMA specification) and the estimated power based on the feedback receive path 250 and/or to correct for a difference between a specified PA gain and an estimated PA gain based on the power estimate 273. The power correction at the time 530 provides a form of gain calibration included within an inner loop power control operation.

By estimating power on-chip in the feedback receive path 250, a time period between adjusting a power output and generating a power correction may be reduced as compared to closed-loop systems that generate power estimates at a baseband processor rather than generating power estimates in a feedback receive path. As a result, accuracy of output power steps during an inner loop power control (ILPC) operation may be increased and power amplifier gain deviations may be detected and compensated in a time period that is shorter than a step duration of the ILPC operation.

In the exemplary embodiments of FIGS. 1-5, transmit power control using the feedback receive path 250 may reduce the number of one or more interface pins between an RF device (e.g., the transceiver chip 202) and a modem device (e.g., the digital baseband chip 204). Die area of the transceiver chip 202 and the baseband chip 204 may also be reduced when the device size is pin-limited. Transmit power control using the feedback receiver path 250 and the serial interface 274 may simplify routing between a modem and a transceiver as compared to using multiple analog pins to provide a feedback signal to the modem. In addition, power consumption may be reduced by reducing routing of analog signals between a transceiver and a modem over a printed circuit board (PCB). Crosstalk due to interfering signals may also be reduced due to a reduced number of analog signals that are routed over a PCB.

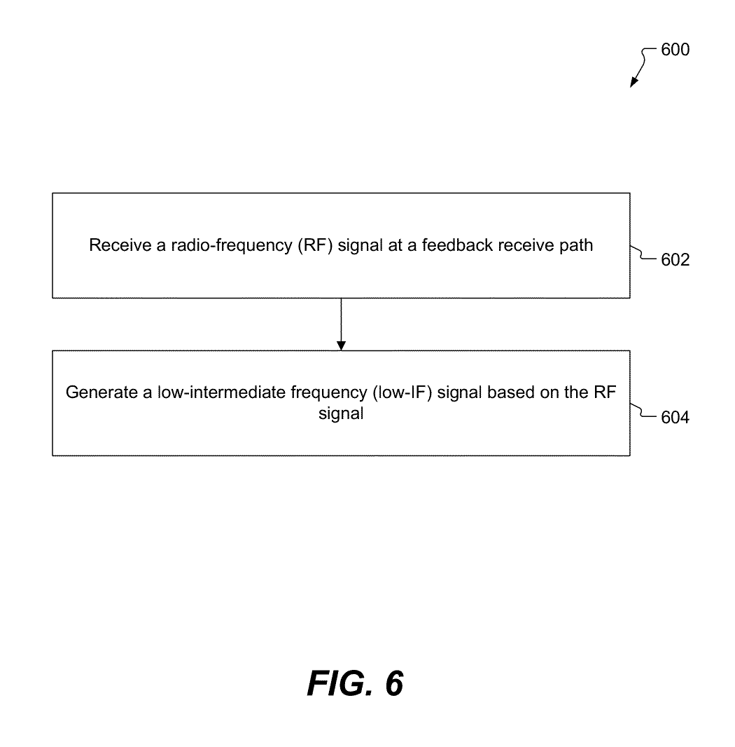

Referring to FIG. 6, an exemplary embodiment of a method is depicted and generally designated 600. The method 600 may be performed in a wireless device that includes a receive feedback path operable in a low-IF mode, such as the wireless device 110 of FIG. 1. For example, the method 600 may be performed by the wireless device 110 as illustrated in any of FIGS. 1-4, as illustrative, non-limiting examples.

A radio-frequency (RF) signal is received at a feedback receive path, at 602. For example, the RF signal may correspond to the RF signal 223 of FIGS. 2-4.

A low-intermediate frequency (low-IF) signal is generated based on the RF signal, at 604. For example, the low-IF signal may be generated at the signal generation circuitry 253 of FIGS. 2-4, such as the low-IF signal 225. For example, the feedback receive path may be operated in the low-IF mode during a calibration phase to generate estimates of one or more parameters to use in a cancellation circuit of the feedback receive path, such as the DC offsets Idc 260 and Qdc 261 of FIG. 2-3. After generating the parameters, the feedback receive path may transition to a baseband mode for power control operations.

A power estimation of the low-IF signal may be generated at the feedback receive path. For example, the power estimator 250 of FIGS. 2-4 may generate estimated power in a quadrature mode (FIG. 2) or in a heterodyne mode (FIG. 3). The power estimation may be transmitted to a digital baseband chip via a serial interface, such as via the serial pin 276 of FIGS. 2-3.

The method 600 may also include determining a DC offset while the feedback receive path is in the low-IF mode. For example, the parameter estimator 282 may receive data (e.g., the power estimation 273) from the feedback receive path 250 while the feedback receive path 250 operates in the low-IF mode and may determine the DC offset, such as Idc 260 and Qdc 261. The feedback receive path may switch from the low-IF mode to a baseband mode after the DC offset is determined. For example, the mixers 240, 241 may switch (e.g., responsive to a control input of the switching circuit 290) between receiving a single tone generator signal 239 from the single tone generator circuit 238 (corresponding to the low-IF mode) and receiving the local oscillator signal 237 from the transmit local oscillator circuit 236 (corresponding to the baseband mode). The DC offset may be applied to a feedback receive signal at the feedback receive path in the baseband mode, such as Idc 260 and Qdc 261 applied by the cancellation circuit 248 in FIG. 2.

Operating the feedback receive path in the low-IF mode enables improved accuracy in generation cancellation parameters, such as DC offsets, for use in baseband mode. As a result, an enhanced accuracy of on-chip power estimation in the baseband mode may be achieved. Transmit power control operations using on-chip power estimation may have reduced delay and improved performance.

Although FIG. 6 depicts a particular order of elements of the method 600, it should be understood that, in other embodiments, elements of the method 600 may be performed in another order. In addition, two or more (or all) of the elements of the method 600 may be performed simultaneously or substantially simultaneously. For example, the RF signal may be transmitted at the transmit path simultaneously with the feedback receive path 250 operating in a low-IF mode.

In conjunction with the disclosed embodiments, an apparatus is described that includes means for receiving a radio-frequency (RF) signal at a feedback receive path. For example, the means for receiving the RF signal may include the input 249 of FIGS. 2-4, one or more other connectors, pins, or conductors, or any combination thereof.

The apparatus also includes means for generating a low-intermediate frequency (low-IF) signal based on the RF signal. For example, the means for generating the low-IF signal may include the low-IF/zero-IF signal generation circuitry 253 of FIGS. 2-4, one or more other mixing or downconversion circuits, or any combination thereof.

The feedback receive path may include means for generating a power estimation based on the low-IF signal, the means for generating the power estimation coupled to the means for generating the low-IF signal. For example, the means for generating the power estimation may include one or more components of the power estimator circuit 266 of FIGS. 2-4, one or more other power estimation circuits, or any combination thereof.

The apparatus may include means for serially outputting a power estimation of the RF signal to a digital baseband chip. For example, the means for serially outputting the power estimation may include the RFFE interface 274 of FIGS. 2-4, the serial output pin 276 of FIGS. 2-4, one or more other circuits or structures to serially output a power estimation to a digital baseband chip, or any combination thereof.

The feedback receive path that is operable in the low-IF mode may be implemented on one or more ICs, analog ICs, RFICs, mixed-signal ICs, ASICs, printed circuit boards (PCBs), electronic devices, etc. The multi-stage filter may also be fabricated using various IC process technologies such as complementary metal oxide semiconductor (CMOS), N-channel MOS (NMOS), P-channel MOS (PMOS), bipolar junction transistor (BJT), bipolar-CMOS (BiCMOS), silicon germanium (SiGe), gallium arsenide (GaAs), heterojunction bipolar transistors (HBTs), high electron mobility transistors (HEMTs), silicon-on-insulator (SOI), etc.

An apparatus implementing a low-IF mode of a receive feedback path as described herein may be a stand-alone device or may be part of a larger device. A device may be (i) a stand-alone IC, (ii) a set of one or more ICs that may include memory ICs for storing data and/or instructions, (iii) an RFIC such as an RF receiver (RFR) or an RF transmitter/receiver (RTR), (iv) an ASIC such as a mobile station modem (MSM), (v) a module that may be embedded within other devices, (vi) a receiver, cellular phone, wireless device, handset, or mobile unit, (vii) etc.

In one or more exemplary designs, the functions described may be implemented in hardware, software, firmware, or any combination thereof. If implemented in software, the functions may be stored as one or more instructions or code on a computer-readable medium. Computer-readable media includes both computer storage media and communication media including any medium that facilitates transfer of a computer program from one place to another. Storage media may be any available media that can be accessed by a computer. In an exemplary embodiment, the storage media is a storage device that stores data. The storage device is not a signal. The storage device may store data based on an optical reflectivity or magnetic orientation of a physical storage material, an amount of charge stored on a floating gate of a transistor or on a plate of a capacitor, etc. By way of example, and not limitation, computer-readable media can comprise RAM, ROM, EEPROM, CD-ROM or other optical disk storage, magnetic disk storage or other magnetic storage devices, or any other medium that can be used to carry or store program code in the form of instructions or data structures and that can be accessed by a computer. Also, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

As used in this description, the terms “component,” “database,” “module,” “system,” and the like are intended to refer to a computer-related entity, either hardware, firmware, a combination of hardware and software, software, or software in execution. To illustrate, the data processor 280 of FIG. 2 may execute program instructions to select values of one or more gain control signals during a closed-loop power control operation based on multi-stage filtering of a feedback receive signal as described herein, to select values of one or more bypass enable signals as described with respect to FIG. 5, to select one or more values of adjustable passive components as described with respect to FIG. 6, or any combination thereof. As illustrative, non-limiting examples, a component may be a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, components may execute from various computer readable media having data structures stored thereon.

Although selected aspects have been illustrated and described in detail, it will be understood that various substitutions and alterations may be made therein without departing from the scope of the present invention, as defined by the following claims.

What is claimed is:

1. An apparatus comprising:
an input configured to receive a radio-frequency (RF) signal at a feedback receive path; and
circuitry coupled to the input and configured to generate a low-intermediate frequency (low-IF) signal based on the RF signal.

2. The apparatus of claim 1, wherein the circuitry is configured to switch between a low-IF mode and a baseband mode.

3. The apparatus of claim 2, wherein the circuitry comprises a mixer having a first mixer input coupled to the input and having a second mixer input, the second mixer input coupled to a single tone generator circuit in the low-IF mode and coupled to a local oscillator circuit in the baseband mode.

4. The apparatus of claim 2, wherein the feedback receive path includes a cancellation circuit coupled to the circuitry, the cancellation circuit including an adder having a first adder input coupled to receive a feedback receive signal at the feedback receive path and having a second adder input coupled to receive a direct-current (DC) offset.

5. The apparatus of claim 4, wherein the cancellation circuit is coupled to the circuitry via filter and sampling circuitry.

6. The apparatus of claim 4, wherein the cancellation circuit further includes:
a second adder coupled to receive a second feedback receive signal and a second direct-current (DC) offset.

7. The apparatus of claim 1, wherein the feedback receive path includes a power estimation circuit coupled to an output of the feedback receive path.

8. The apparatus of claim 7, wherein the power estimation circuit includes a first squaring circuit coupled to receive samples of a first feedback signal in the feedback receive path.

9. The apparatus of claim 8, wherein the power estimation circuit further includes:
a second squaring circuit coupled to receive samples of a second feedback signal in the feedback receive path; and
an adder coupled to the first squaring circuit and to the second squaring circuit.

10. The apparatus of claim 1, further comprising:
filter and sampling circuitry coupled to the circuitry; and
a cancellation circuit coupled to the filter and sampling circuitry.

11. The apparatus of claim 10, further comprising a power estimation circuit coupled to the cancellation circuit, wherein an output of the power estimation circuit is coupled to a serial output pin.

12. The apparatus of claim 11, further comprising a RF front-end (RFFE) serial interface coupled to the output of the power estimation circuit and to the serial output pin.

13. The apparatus of claim 1, wherein the input is coupled to an RF output of a transmit path, wherein the transmit path and the feedback receive path are on a transceiver chip that includes multiple pins, and wherein the transceiver chip further comprises a receive path coupled to a baseband chip via an analog output pin.

14. The apparatus of claim 13, wherein the transceiver chip further includes a switching circuit having a switching circuit input coupled to an output of the circuitry and having a switching circuit output coupled to the receive path.

15. An apparatus comprising:
means for receiving a radio-frequency (RF) signal at a feedback receive path; and
means for generating a low-intermediate frequency (low-IF) signal based on the RF signal.

16. The apparatus of claim 15, wherein the feedback receive path includes means for generating a power estimation based on the low-IF signal, the means for generating the power estimation coupled to the means for generating the low-IF signal.

17. The apparatus of claim 15, wherein the means for generating the low-intermediate frequency (low-IF) signal is configured to switch between a low-IF mode and a baseband mode.

18. The apparatus of claim 15, further comprising means for serially outputting a power estimation of the RF signal to a digital baseband chip.

19. A method comprising:
receiving a radio-frequency (RF) signal at a feedback receive path; and
generating a low-intermediate frequency (low-IF) signal based on the RF signal.

20. The method of claim 19, further comprising:
generating a power estimation of the low-IF signal at the feedback receive path; and
sending the power estimation via a serial output pin to a digital baseband chip.
